(19) United States
(12) Patent Application Publication
(10) Pub. No.: US 2026/0159074 A1
(43) Pub. Date: Jun. 11, 2026

(54) OBJECT IDENTIFICATION AND ACCIDENT PREVENTION FOR VEHICLES IN HAZARDOUS CONDITIONS

(71) Applicant: Volvo Car Corporation, Göteborg (SE)

(72) Inventor: Oswaldo Perez Barrera, Gothenburg (SE)

(21) Appl. No.: 18/956,954

(22) Filed: Nov. 22, 2024

(51) Int. Cl. B60W 30/09; B60W 30/095; B60W 30/14; B60W 50/00; B60W 50/14

(52) U.S. Cl. CPC B60W 30/09; B60W 30/0956; B60W 30/146; B60W 50/14; B60W 2050/0083; B60W 2420/403; B60W 2420/408; B60W 2554/4029; B60W 2554/4042; B60W 2554/80; B60W 2555/20; B60W 2556/45

(57) ABSTRACT

Techniques for object identification and accident prevention for vehicles in hazardous (e.g., low visibility) conditions are provided. In an example, a method comprises detecting, by a system onboard a vehicle comprising a processor, a hazard that reduces visibility. The method can further comprise detecting, by the system, an object using radar, and determining, by the system, a level of visibility of the object. The method can further comprise regulating, by the system, operation of the vehicle based on the detected hazard, detected object, and determined level of visibility of the object.

### TECHNICAL FIELD

The disclosed subject matter relates to vehicles (e.g., transportation vehicles), and more particularly, to object identification and accident prevention systems for vehicles in hazardous (e.g., low visibility) conditions.

### BACKGROUND

Fog is a leading contributor to hazardous driving conditions, often resulting in increased likelihood of traffic accidents due to the limited visibility it imposes. When fog settles on the road, it creates a dense atmosphere that disrupts a driver's ability to see obstacles and accurately judge distances. This can lead to dangerous misjudgments regarding movements and speeds of surrounding vehicles. The optical illusions generated by fog, such as the perceived proximity of objects, further compound these challenges. The inability to correctly estimate distance or differentiate between stationery and moving objects can result in severe accidents, including large-scale pileups. Drivers in foggy conditions must navigate these risks without effective aids, often relying solely on reduced speeds or hazard lights, both of which are insufficient in adequately counteracting the dangers of dense fog.

Despite these risks, current technological solutions for driving in reduced visibility conditions are limited, and primarily rely on radar systems. While radar is useful in detecting objects ahead, its limitations become evident in fog, where visibility challenges are exacerbated. Radar systems struggle to distinguish between different levels of visibility and fail to adjust the detection range based on these conditions, making it difficult to provide drivers with real-time situational awareness. Additionally, radar systems do not consistently communicate the car's position relative to other moving vehicles on the road, leaving drivers without a reliable system to gauge visibility or safely interact with other vehicles. These shortcomings point to a need for more advanced, adaptable technology that can improve visibility in low-clarity conditions, ultimately helping prevent fog-related accidents.

The above-described background relating to object identification and accident prevention systems for vehicles in hazardous conditions is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products can facilitate early detection of hazardous road conditions and enable proactive adjustment to vehicle dynamics.

Fog is a major factor in creating hazardous driving conditions, significantly raising the chances of traffic accidents due to the restricted visibility it causes. When fog envelops a roadway, it forms a thick layer that impairs drivers'abilities to detect obstacles and accurately gauge distances. This often leads to risky misjudgments about the speed and movement of nearby vehicles. The illusions fog creates, such as distorted perceptions of how close objects appear, add to these difficulties. Without an accurate sense of distance or a clear distinction between moving and stationary objects, drivers face an elevated risk of serious accidents, including large multi-vehicle collisions. Navigating through foggy conditions presents drivers with substantial risks, and the typical precautions—such as slowing down or using hazard lights—are often inadequate for addressing the unique challenges of dense fog.

The proposed solution leverages a system where an autonomous vehicle (“AV”) can continuously monitor and track visibility conditions of road sections. The AV can detect objects using radar and, after an object has been detected with the radar, the AV can attempt to detect the same object using visual sensors. The AV can repeat this process until a visual sensor detects the object. This process can be repeated with several objects. The AV can save the distance at which the object was detected with the visual sensor, and use this distance value to determine a “visibility distance” of the object. The visibility distance can vary between objects. For example, an illuminated object (such as another vehicle with activated lights) can be visible to at a greater distance than an object without any illumination. Thus, the determined visibility distance can be object specific. The AV can further determine its own visibility distance with respect to other vehicles on the road (that is, the AV can determine at what distance it will become visible to nearby other vehicles or pedestrians). This information can be relayed to other drivers or pedestrians, enabling them to anticipate hazardous conditions and adjust their driving accordingly before an accident occurs. In some embodiments, the vehicle can autonomously adjust driving parameters to enhance safety and maintain optimal control in response to changing visibility conditions. Such a system can significantly enhance driver awareness, response times, and roadway safety offering a cost-effective means of improving safety in areas that pose risk during reduced visibility conditions.

As alluded to above, improved techniques for visibility level estimation and proactive vehicle safety control are desirable, and various embodiments are described herein to this end and/or other ends.

According to an embodiment, a system can comprise a memory that stores computer executable components, and a processor that executes the computer executable components stored in the memory, including a hazard detection component that detects a hazard that reduces visibility, and an object detection component that detects an object using radar. The computer executable components can further comprise a visibility component that determines a level of visibility of the object, and a regulation component that regulates operation of the vehicle based on the detected hazard, detected object, and determined level of visibility of the object.

According to another embodiment, a method can comprise detecting, by a system onboard a vehicle comprising a processor, a hazard that reduces visibility, and detecting, by the system, an object using radar. The method can further comprise determining, by the system, a level of visibility of the object. The method can further comprise regulating, by the system, operation of the vehicle based on the detected hazard, detected object, and determined level of visibility of the object.

According to yet another embodiment, a non-transitory machine-readable medium can comprise executable instructions that, when executed by a processor integrated on or within a vehicle, facilitate performance of operations, comprising, detecting a hazard that reduces visibility, detecting an object using radar, determining a level of visibility of the object, and regulating operation of the vehicle based on the detected hazard, detected object, and determined level of visibility of the object.

### BRIEF DESCRIPTION OF DRAWINGS

FIGS. 1-2 illustrate block diagrams of exemplary friction estimation systems, in accordance with one or more embodiments described herein.

FIG. 3 illustrates example road scenarios for object visibility estimation in accordance with one or more embodiments described herein.

FIG. 4 illustrates example road scenarios for object visibility estimation in accordance with one or more embodiments described herein.

FIG. 5 illustrates example road scenarios for object visibility estimation in accordance with one or more embodiments described herein.

FIG. 6 illustrates example road scenarios for object visibility estimation in accordance with one or more embodiments described herein.

FIG. 7 illustrates example road scenarios for object visibility estimation in accordance with one or more embodiments described herein.

FIG. 8 illustrates example road scenarios for object visibility estimation in accordance with one or more embodiments described herein.

FIGS. 9A and 9B illustrates flow diagrams of example, non-limiting computer implemented methods that can facilitate early detection of hazardous road conditions and enable proactive adjustment to vehicle dynamics in accordance with one or more embodiments described herein.

FIG. 10 is an example of a non-limiting computing environment in which one or more embodiments described herein can be implemented.

FIG. 11 is an example of a non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As alluded to above, improved techniques for object visibility estimation and proactive vehicle safety control are desirable, and various embodiments are described herein to this end and/or other ends. In accordance with one or more embodiments, the disclosed solution provides a safety system for vehicles that facilitates early detection of hazardous road conditions and proactive adjustments to vehicle dynamics. In various embodiments, the onboard computer system of the vehicle can comprise a memory that stores computer-executable components, and a processor that executes the computer executable components stored in the memory. These computer-executable components can include a hazard detection component that detects a hazard that reduces visibility, and an object detection component that detects an object using radar. The computer-executable components can further comprise a visibility component that determines a level of visibility of the object, and a regulation component that regulates operation of the vehicle based on the detected hazard, detected object, and determined level of visibility of the object.

In some embodiments, the visibility component uses a camera to determine the level of visibility of the object. Upon detection of the object by the object detection component, the visibility component can continuously attempt to detect the object with the camera. The visibility component can detect the object with the camera, and determine a distance between the detected object and the vehicle.

In some embodiments, the object detection component determines the distance between the vehicle and the object at the time the object is detected with radar. The visibility component can determine a distance between the vehicle and the object at the time the object becomes visible to the camera. The visibility component can determine that the object is only visible at a reduced distance to the vehicle. The visibility component can further determine a zone of visibility for the vehicle based upon the reduced distance between the object and the vehicle at the time the object is visible.

In some embodiments, the detected hazard comprises at least one of fog, smoke, or darkness. In other embodiments, the detected object is another vehicle. In such cases, the object detection component can further determine a size or speed of the detected vehicle. The object detection component can determine an average braking distance for the detected vehicle. According to another embodiment, the detected object can be a pedestrian.

In some embodiments, the regulation component reduces speed of the vehicle. The regulation component can activate a light of the vehicle, change a setting of the vehicle, or transmit a warning to a user of the vehicle. In other embodiments, the regulation component can facilitate driving of the vehicle based on the detected object and estimated visibility. In further embodiments, the vehicle can proactively notify the driver of the road conditions or object or can automatically modify driving parameters, such as reducing speed, adjusting braking force, or altering steering inputs, to maintain optimal control, thereby enhancing overall safety.

In various embodiments, the object detection component can submit a warning report to a cloud server indicating the location of the detected object.

In some embodiments an artificial intelligence component can be used to regulate control of the vehicle based on the detected object and estimated visibility.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments described herein.

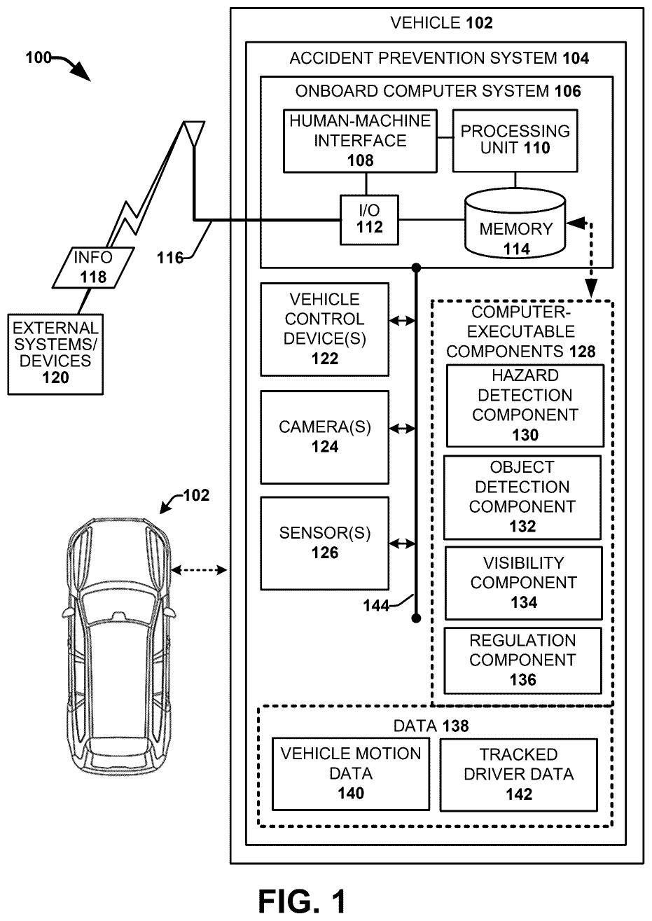

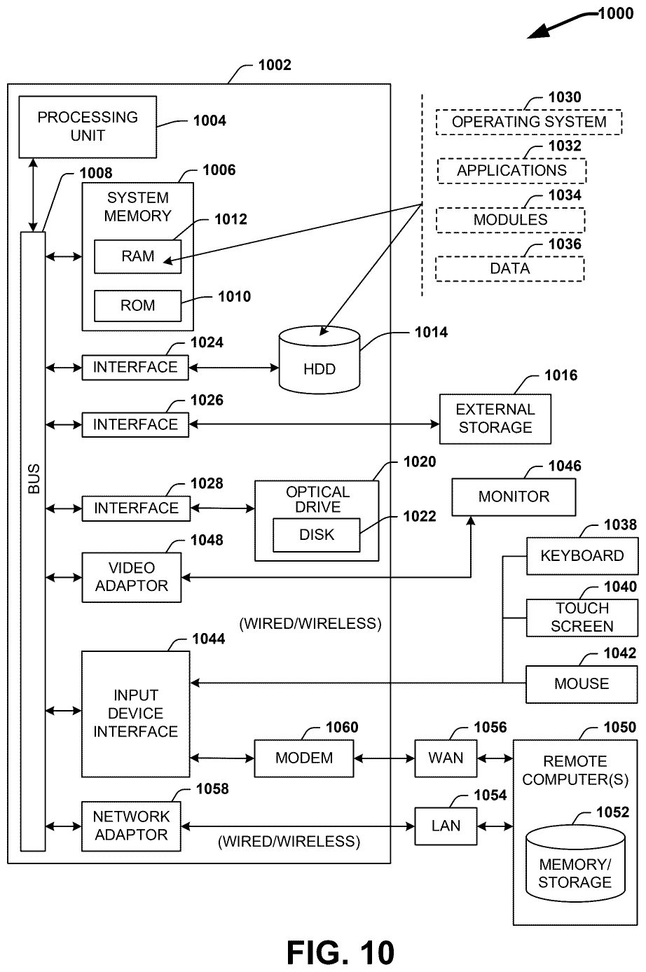

Turning now to the drawings, FIG. 1 illustrates a block diagram of an exemplary system 100 that facilitates early detection of hazardous road conditions and proactive adjustments to vehicle dynamics. System 100 includes a vehicle 102 comprising an accident prevention system 104 integrated thereon or therein. The accident prevention system 104 includes one or more vehicle control device 122, one or more cameras 124, one or more sensors 126 and an onboard computer system 106. The onboard computer system 106 comprises at least one memory 114 that stores computer-executable components 128 and data 138 that facilitate early detection of hazardous road conditions and enables proactive adjustments to vehicle dynamics of vehicle 102. These computer-executable components include (but are not limited to) hazard detection component 130, object detection component 132, visibility component 134 and regulation component 136. The onboard computer system 106 includes at least one processor or processing unit 110 that executes the computer-executable component 128 stored in memory 114 to carry out the operations/functions described with respect to the corresponding computer-executable components. Examples of said memory 114, processing unit 110, and other computer system components that can be included in the onboard computer system 106 to facilitate the various features and functionalities of system 100 can be found with reference to FIG. 10 (e.g., system memory 1010, processing unit 1004, and the like).

The onboard computer system 106 can further include an input/output (I/O) component 112, wherein the I/O component 112 can be a transceiver configured to enable transmission/receipt of information 118 between the onboard computer system 106 and various external systems or devices 120. For example, the external systems or devices 120 can correspond to any type of device or computing system configured to wirelessly communicate (e.g., using radio frequency signals) with the onboard computer system 106, such as but not limited to, a mobile device associated with one or more users of the vehicle 102 (e.g., a smartphone, a smartwatch, a tablet, eyewear, a wearable headset or another type of wearable device), an external computer, an external computer system, an external application server, another vehicle's onboard computer system, and so on. The I/O component 112 can be communicatively coupled, via an antenna 116, to the remotely located devices and systems (e.g., external systems/devices 120). Any suitable technology can be utilized to enable the various embodiments presented herein, regarding transmission and receiving of information 118 between the onboard computer system 106 and one or more external systems/devices 120. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

The onboard computer system 106 can also include a human-machine interface 108 that provides for receiving user input in association with utilizing the various features and functionalities of the computer-executable component 134 and presenting information to users. For example, the human-machine interfaces 108 can include or correspond to any suitable output device such as a display, a speaker, etc. and any suitable input device, such as a touchscreen display, a microphone, a keypad, a keyboard, a camera, a gesture input device/system, a voice input device/system, and the like. Examples of suitable input and output devices of the human-machine interface 108 devices are further provided with reference to FIG. 10. The friction estimation system 104 also include a system bus 144 that communicatively and operatively couples the onboard computer system 106, the one or more vehicle control device 122, the one or more cameras 124 and the one or more sensors 126 to one another using any suitable wired or wireless communication technology.

Vehicle 102 can correspond to any suitable type of transportation vehicle comprising one or more windows and adapted for use in scenarios in which monitoring the external environment is important, such as varying weather conditions or navigation in complex environments. For instance, vehicle 102 can include or correspond to any suitable type of motor vehicle (e.g., a car, a truck, a van, a sport utility vehicle (SUV), etc.). In some implementations vehicle 102 can also include or correspond to an aircraft (e.g., an airplane, a helicopter, or the like), a watercraft, or another type of passenger transportation vehicle. In some embodiments, vehicle 102 can include or correspond to an autonomous vehicle that is capable of navigating and operating without (or some) human input.

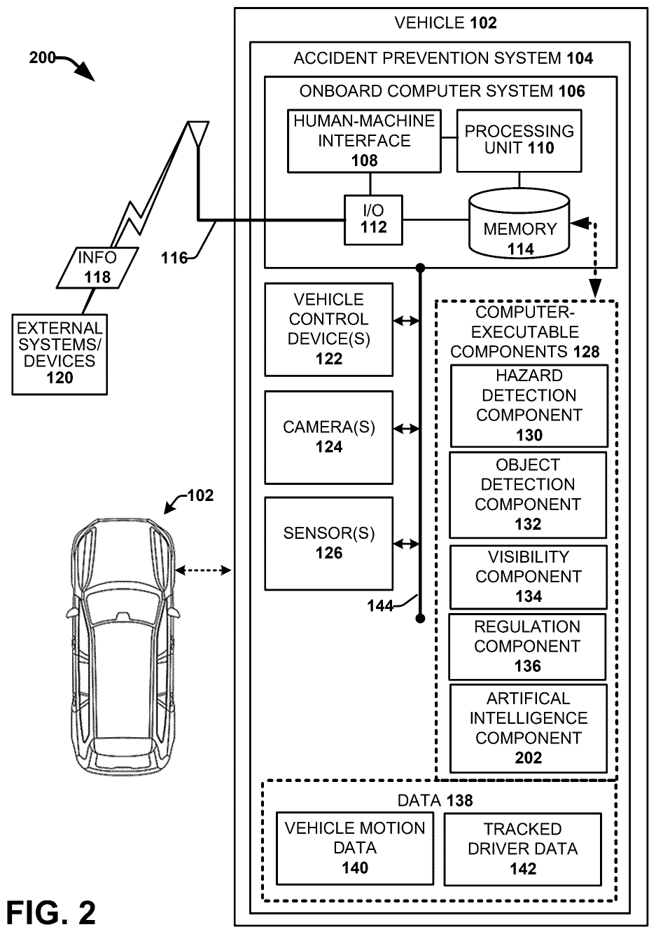

FIG. 2 illustrates an example system 200 that can facilitate early detection of hazardous road conditions and enables proactive adjustments to vehicle dynamics of vehicle 102. System 200 includes a vehicle 102 comprising a friction estimation system 104 integrated thereon or therein. The friction estimation system 104 includes one or more vehicle control device 122, one or more cameras 124, one or more sensors 126 and an onboard computer system 106. The onboard computer system 106 comprises at least one memory 114 that stores computer-executable components 128 and data 138 that facilitate early detection of hazardous road conditions and enables proactive adjustments to vehicle dynamics of vehicle 102. System 200 includes computer-executable components (but are not limited to) including hazard detection component 130, object detection component 132, visibility component 134 and regulation component 136, and artificial intelligence component 202.

The hazard detection component 130 detects a hazard that reduces visibility. The hazard can further comprise at least one of smoke, fog, darkness, or any other environmental condition or circumstance which can impair visibility.

The object detection component 132 detects an object using radar. In some embodiments, the detected object is another vehicle. In such cases, the object detection component 132 can further determine a size or speed of the detected vehicle. The object detection component 132 can determine an average braking distance for the detected vehicle. According to another embodiment, the detected object can be a pedestrian. In such cases, the object detection component 132 can further determine a size or speed of the detected pedestrian. In various embodiments, the object detection component can submit a warning report to a cloud server indicating the location of the detected object.

The visibility component 134 determines a level of visibility of the object. In some embodiments, the visibility component 134 uses a camera to determine the level of visibility of the object. Upon detection of the object by the object detection component 132, the visibility component 134 can continuously attempt to detect the object with the camera. The visibility component 134 can detect the object with the camera, and determine a distance between the detected object and the vehicle.

In some embodiments, the object detection component 132 can determine the distance between the vehicle and the object at the time the object is detected with radar. The visibility component 134 can determine a distance between the vehicle and the object at the time the object becomes visible to the camera. The visibility component 134 can determine that the object is only visible at a reduced distance to the vehicle. The visibility component 134 can further determine a zone of visibility for the vehicle based upon the reduced distance between the object and the vehicle at the time the object is visible.

The regulation component 136 facilitates driving of the vehicle based on the detected hazard, detected object, and determined level of visibility of the object. In some embodiments, the regulation component 136 reduces speed of the vehicle. The regulation component 136 can activate a light of the vehicle, change a setting of the vehicle, or transmit a warning to a user of the vehicle. In other embodiments, the regulation component 136 can facilitate driving of the vehicle based on the detected object and estimated visibility. In further embodiments, the regulation component 136 can proactively notify a driver or passenger of the vehicle of the road conditions or object or can automatically modify driving parameters, such as reducing speed, adjusting braking force, or altering steering inputs, to maintain optimal control, thereby enhancing overall safety.

The artificial intelligence component 202 regulates control of the vehicle based on the detected hazard, detected object, and determined level of visibility of the object. The onboard computer system 106 includes at least one processor or processing unit 110 that executes the computer-executable component 128 stored in memory 114 to carry out the operations/functions described with respect to the corresponding computer-executable components. In various embodiments, artificial intelligence component 202 can regulate vehicle control based on real-time analysis of the detected hazard, detected object, and determined level of visibility of the object. The artificial intelligence component 202 can adjust driving parameters, such as speed, braking, and steering, to optimize vehicle stability and safety under varying road conditions.

The systems and/or devices are described herein with respect to interaction between one or more components. Such systems and/or components can include the components and/or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity but known by those of skill in the art.

One or more systems, devices, computer program products, and/or computer-implemented methods provided herein relate to object detection and accident prevention for vehicles in hazardous conditions. A system can include a processor that executes computer executable components stored in memory. The computer executable components can include a hazard detection component that detects a hazard that reduces visibility, and an object detection component that detects an object using radar. The computer-executable components can further comprise a visibility component that determines a level of visibility of the object, and a regulation component that regulates operation of the vehicle based on the detected hazard, detected object, and determined level of visibility of the object.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 110 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

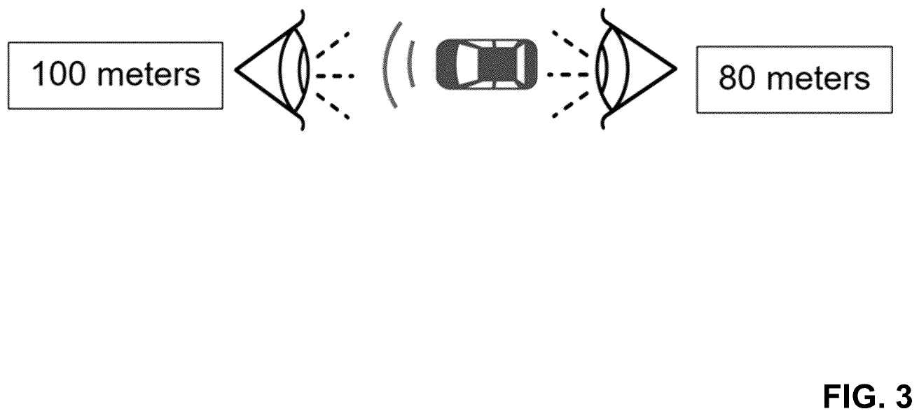

FIG. 3 illustrates example road scenarios for object visibility estimation in accordance with one or more embodiments described herein. In an embodiment, the AV can determine its own visibility distances in reduced visibility conditions by using the visibility distances of other vehicles respective to the AV. For example, the AV can determine that there is a first vehicle (“V1”) driving in front of the AV. The AV can further determine that V1 is visible as X meters. AV can therefore determine that V1 has a visibility distance of X meters. AV can therefore infer that its own visibility distance (e.g., when seen from behind) is similar to the visibility distance of X meters of V1. Thus, AV can determine that its own visibility distance is close to X meters. However, the visibility difference of AV and V1 can vary, even in similar conditions, due to differences between AV and V1, such as size or light conditions. For example, AV can be larger and have brighter lights than V1. Therefore, AV can determine that it will be more easily visible than V1, and that AV's visibility distance is greater than the X meter visibility distance of V1.

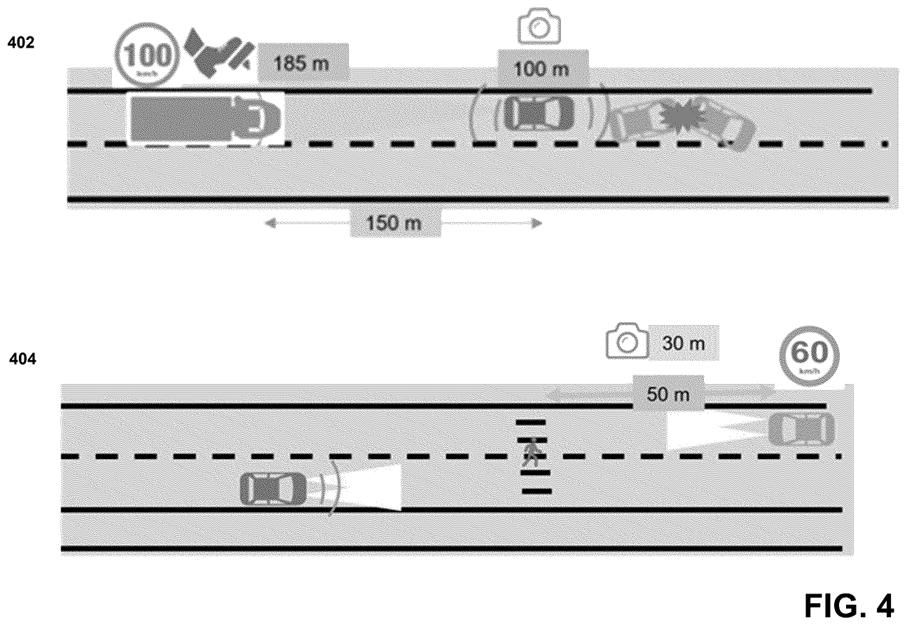

Next, FIG. 4 illustrates example road scenarios for object visibility estimation in accordance with one or more embodiments described herein. At 402, the AV can detect at least one vehicle (“V1,” “V2,” etc.) driving behind it. The AV can detect the dimensions and distances of the detected vehicle(s) with respect to the AV. The AV can compare a “current distance” between AV and V1 against a determined “safe braking distance” of AV and V1 or against a determined visibility distance” between AV and V1. The “safe braking distance” of AV and V1 can be the minimum distance between AV and V1 required to avoid a collision in the event of a sudden brake by the vehicle in front (in the example illustrated above, AV is the vehicle in front of V1, so the determined “safe braking distance” can by the minimum distance between AV and V1 required to avoid a collision in the event of AV suddenly stopping). If the “visibility distance” for AV is smaller than the “safe braking distance,” the “current distance” can be similar to or smaller than the “safe braking distance,” of the vehicle approaching the AV. In response to such a determination, the AV can adjust its driving, for example, by making a lane change. A driving suggestion can also be issued to a driver of a vehicle. Thus, if the AV needs to brake abruptly, any surrounding vehicles (including those behind the AV) will not be a threat (e.g., risk of collision will be reduced). At 404, for sensitive objects, such as a pedestrian or a big animal, the AV can upload a notification to a server, thereby alerting other vehicles in the vicinity.

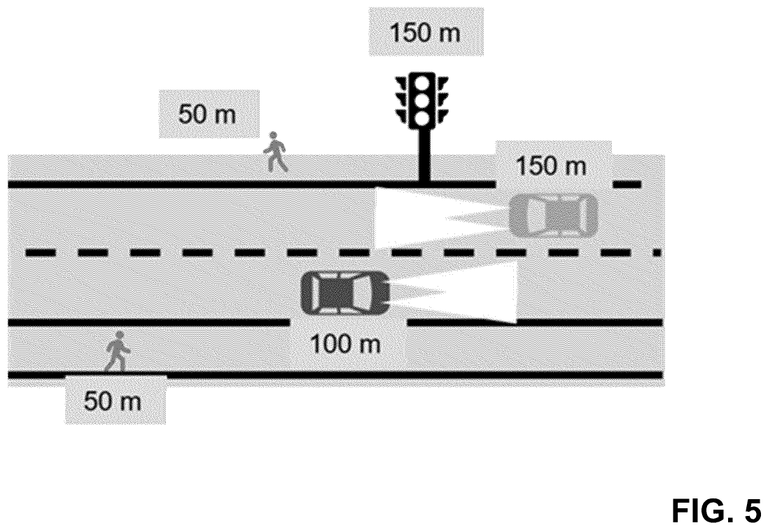

Next, FIG. 5 illustrates example road scenarios for object visibility estimation in accordance with one or more embodiments described herein. The AV can determine a “visibility distance value” (“VDV”) of an object and assign the VDV to the object. The VDV can be calculated by first detecting the object using radar and then determining when the object is detected by a visual sensor (such as a camera). The VDV can be the distance between the object and the AV when the object is detected by a visual sensor (e.g., when the object “becomes visible”). The AV can use the VDV to adjust driving parameters of the vehicle, or to alert other vehicles or drivers of the detected object and visibility level of the object. For example, if the AV detects that a pedestrian is crossing and determines that visibility of the pedestrian is reduced (e.g., the VDV is low, due to hazardous conditions), the AV can adjust driving parameters, such as speed, braking, and steering, to optimize vehicle stability and safety and to maximize safety of the pedestrian. The AV can also alert other vehicles or drivers of the detected pedestrian, thereby reducing the risk of an accident.

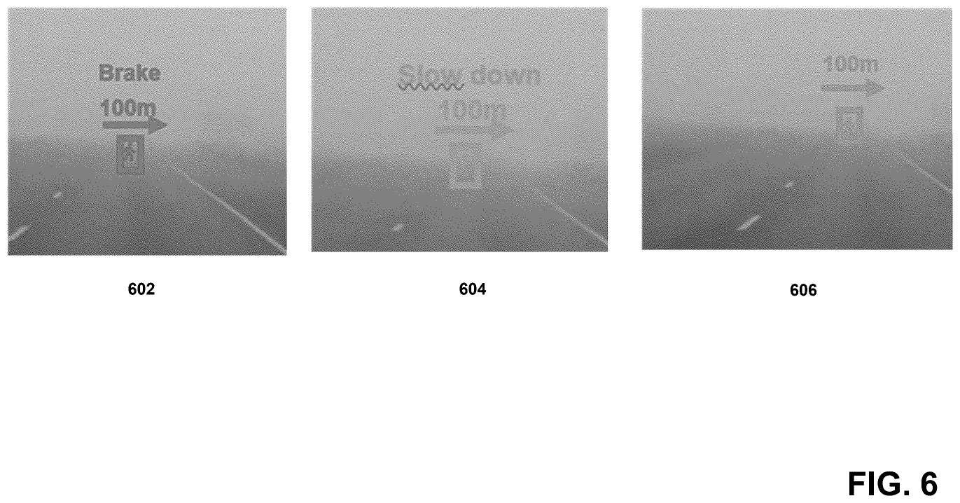

FIG. 6 illustrates example road scenarios for object visibility estimation in accordance with one or more embodiments described herein. The AV can first detect an object in reduced visibility conditions using radar. The AV can determine a location of the object using radar. The AV can further determine features of the object, such as size and shape, using radar. The AV can determine a likely identity of the object, based on the determined features. The AV can attempt to detect the object using visual sensors (e.g., using cameras). The AV can determine that the detected object is not visible using the visual sensors. The AV can thus determine that the detected object is not visible to the vehicle. Since the location of the object is known, the AV can identify the object in a heads-up display of the vehicle, along with accompanying instructions. If the object is a pedestrian, the notification can include a pedestrian icon. Similarly, if the object is an, the notification could include an animal icon. Thus, the notification can include an icon which represents the detected object. The notification can include information about the identified object, instructions pertaining to driving of the AV, or any other information which could be useful. For example, based on the AV's speed and distance to the object, and the AV's determined braking distance, the AV can issue a notification such as “traffic light ahead, reduce speed,” thereby alerting a whether the driving speed of the AV is appropriate.

At 602, the AV determines that there is a pedestrian ahead of the vehicle. The AV identifies the pedestrian and the location (100 m to the right, as indicated by the arrow) of the pedestrian in the heads-up display, along with the accompanying instruction “Brake.”

At 604, the AV determines that there is a pedestrian ahead of the vehicle. The AV identifies the pedestrian and the location (100 m to the right, as indicated by the arrow) of the pedestrian in the heads-up display, along with the accompanying instruction “Slow Down.”

At 606, the AV determines that there is a pedestrian ahead of the vehicle. The AV identifies the pedestrian and the location (100 m to the right, as indicated by the arrow) of the pedestrian in the heads-up display.

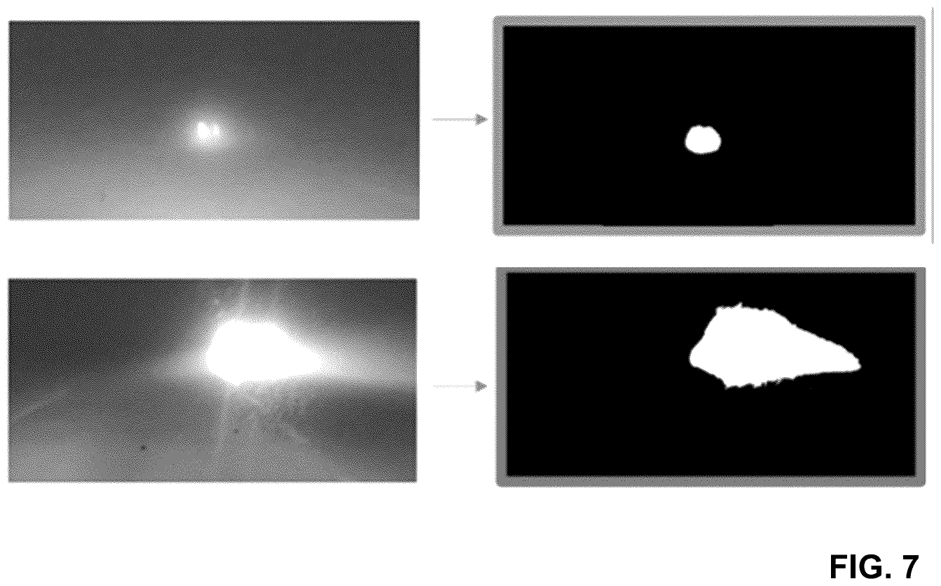

Next, FIG. 7 illustrates example road scenarios for object visibility estimation in

accordance with one or more embodiments described herein. The AV can detect oncoming vehicles and their lights. The AV can detect the oncoming vehicle and based on the distance between the detected vehicle and the AV, the AV can perform light analysis. In an embodiment, if a driver of the AV is using high beams, the AV can detect an oncoming vehicle and inform the driver of the AV to turn off the high beams. In another embodiment, the AV can automatically turn off the high beams. In yet another embodiment, the AV can issue a warning to the other vehicle's driver in order to prevent dazzling. In an embodiment, if a driver of an oncoming vehicle is using high beams, the AV can detect the oncoming vehicle and inform the driver of the AV to avoid looking at the oncoming vehicle's lights, thereby reducing the risk of dazzling. In yet another embodiment, the AV can issue a warning to the other vehicle's driver to turn off the high beams of the oncoming vehicle in order to prevent dazzling. FIG. 7 illustrates an example perspective of two vehicles at the same distance X from the AV but with different lights.

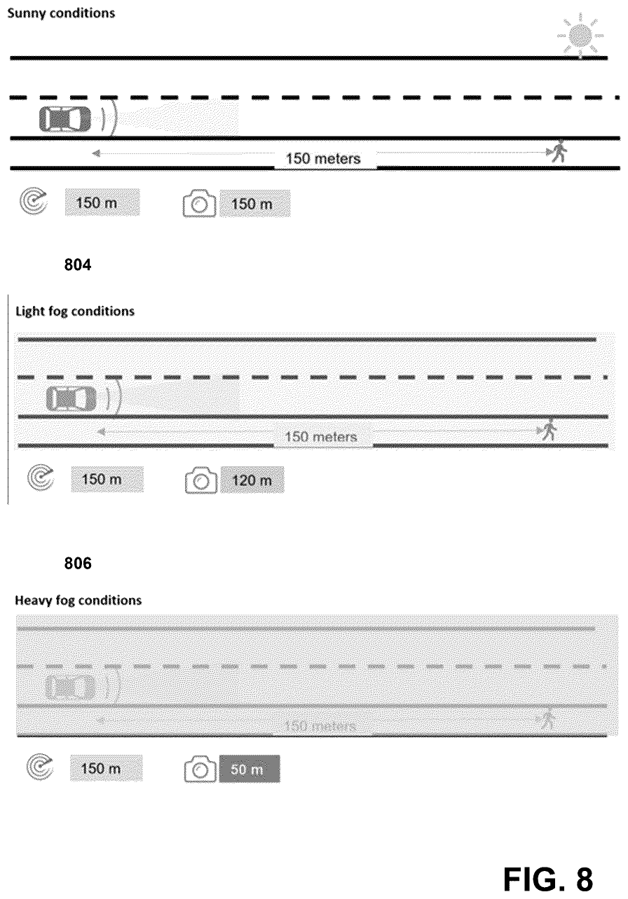

Next, FIG. 8 illustrates example road scenarios for object visibility estimation in accordance with one or more embodiments described herein. In order to help the AV to determine a current level of, the AV can access a database of expected visibility distances for different objects and compare them to determined “current visibility distances.” In some embodiments, the AV can update the database of expected visibility distances for different objects with the determined “current visibility distances.”

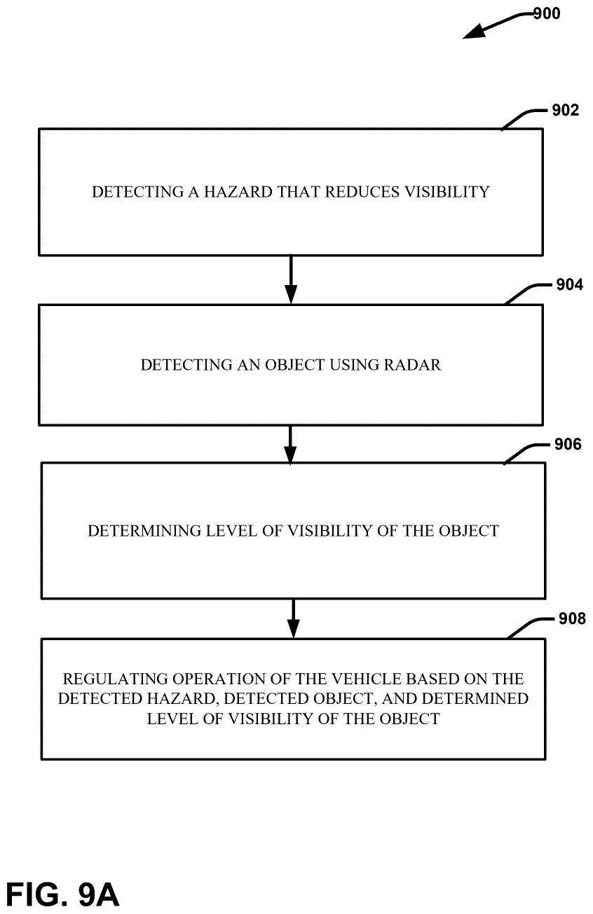

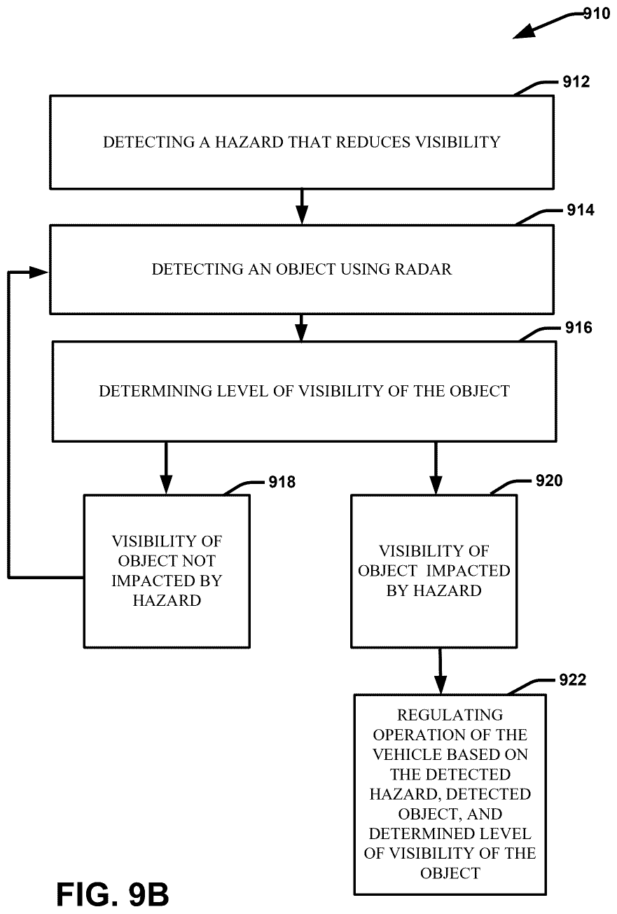

Next, FIGS. 9A and 9B illustrates flow diagrams of methods that can facilitate early detection of hazardous road conditions and enables proactive adjustments to vehicle dynamics in accordance with some embodiments described herein, such as the system 200 of FIG. 2 and the system 100 of FIG. 1. While the methods 900 and 910 are described relative to the system 200 of FIG. 2, the methods 900 and 910 can be applicable also to other systems described herein. Repetitive description of like elements and/or processes employed in respective embodiments is omitted for sake of brevity.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

FIG. 9A illustrates a flow diagram of a method 900 that can facilitate early detection of hazardous road conditions and enables proactive adjustments to vehicle dynamics in accordance with some embodiments described herein.

At 902, the method 900 includes detecting a hazard that reduces visibility. The method 900 can use a system operatively coupled to the processor (e.g., hazard detection component 130) to detect the hazard.

At 904, method 900 includes detecting an object using radar. The method 900 can use a system operatively coupled to the processor (e.g., object detection component 132) to detect the object.

At 906, method 900 includes determining a level of visibility of the object. The method 900 can use a system operatively coupled to the processor (e.g., visibility component 134) to determine the level of visibility of the object.

At 908, method 900 includes regulating operation of the vehicle based on the detected hazard, detected object, and determined level of visibility of the object. The method 900 can use a system operatively coupled to the processor (e.g., regulation component 136) to regulate operation of the vehicle.

In some embodiments, method 900 is performed by a system, such as system 100 of FIG. 1 or system 200 of FIG. 2.

FIG. 9B illustrates a flow diagram of a method 910 that can facilitate early detection of hazardous road conditions and enables proactive adjustments to vehicle dynamics in accordance with some embodiments described herein.

At 912, the method 910 includes detecting a hazard that reduces visibility. The method 910 can use a system operatively coupled to the processor (e.g., hazard detection component 130) to detect the hazard.

At 914, method 910 includes detecting an object using radar. The method 910 can use a system operatively coupled to the processor (e.g., object detection component 132) to detect the object.

At 916, method 910 includes determining a level of visibility of the object. The method 910 can use a system operatively coupled to the processor (e.g., visibility component 134) to determine the level of visibility of the object. Determining a level of visibility of the object can include determining that the visibility of the object is impacted by the detected hazard. Determining a level of visibility of the object can include determining that the visibility of the object is not impacted by the detected hazard.

At 918, in response to determining that the visibility of the object is not impacted by the detected hazard, the method 910 includes returning to 914 and searching for a new object to detect. The method then repeats.

At 920, in response to determining that the visibility of the object is impacted by the detected hazard, the method 910 includes proceeding to 922.

At 922, method 910 includes regulating operation of the vehicle based on the detected hazard, detected object, and determined level of visibility of the object. The method 910 can use a system operatively coupled to the processor (e.g., regulation component 136) to regulate operation of the vehicle.

In some embodiments, method 910 is performed by a system, such as system 100 of FIG. 1 or system 200 of FIG. 2.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors, field-programmable gate array, AI accelerator application-specific integrated circuit, or other suitable processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data. It is noted that unified Extensible Firmware Interface(s) can be utilized herein.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a disc 1022 such as a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

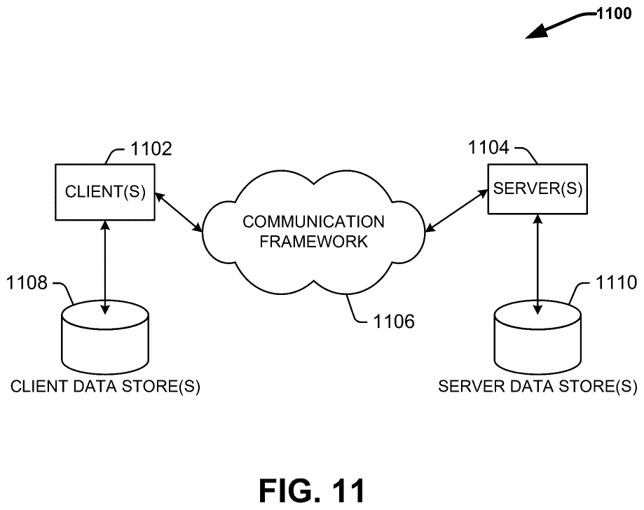

Referring now to FIG. 11, there is illustrated a schematic block diagram of a computing environment 1100 in accordance with this specification. The system 1100 includes one or more client(s) 1102, (e.g., computers, smart phones, tablets, cameras, PDA's). The client(s) 1102 can be hardware and/or software (e.g., threads, processes, computing devices). The client(s) 1102 can house cookie(s) and/or associated contextual information by employing the specification, for example.

The system 1100 also includes one or more server(s) 1104. The server(s) 1104 can also be hardware or hardware in combination with software (e.g., threads, processes, computing devices). The servers 1104 can house threads to perform transformations of media items by employing aspects of this disclosure, for example. One possible communication between a client 1102 and a server 1104 can be in the form of a data packet adapted to be transmitted between two or more computer processes wherein data packets may include coded analyzed headspaces and/or input. The data packet can include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104. Further, the client(s) 1102 can be operatively connected to one or more server data store(s) 1110.

In one exemplary implementation, a client 1102 can transfer an encoded file, (e.g., encoded media item), to server 1104. Server 1104 can store the file, decode the file, or transmit the file to another client 1102. It is noted that a client 1102 can also transfer uncompressed file to a server 1104 and server 1104 can compress the file and/or transform the file in accordance with this disclosure. Likewise, server 1104 can encode information and transmit the information via communication framework 1106 to one or more clients 1102.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:
1. A system, comprising: one or more sensors integrated on or within a vehicle; a memory that stores computer executable components; and a processor that executes the computer executable components stored in the memory, wherein the computer executable components comprise: a hazard detection component that detects a hazard that reduces visibility; an object detection component that detects an object using radar; a visibility component that determines level of visibility of the object; and a regulation component that regulates operation of the vehicle based on the detected hazard, detected object, and determined level of visibility of the object.
2. The system of any one or more preceding clause(s), wherein the visibility component uses a camera to determine the level of visibility of the object.
3. The system of any one or more preceding clause(s), upon detection of the object by the object detection component, the visibility component continuously attempts to detect the object with the camera.
4. The system of any one or more preceding clause(s), wherein the visibility component detects the object with the camera, and determines a distance between the detected object and the vehicle.
5. The system of any one or more preceding clause(s), wherein the object detection component determines the distance between the vehicle and the object at the time the object is detected with radar.
6. The system of any one or more preceding clause(s), wherein the visibility component determines a distance between the vehicle and the object at the time the object becomes visible to the camera.
7. The system of any one or more preceding clause(s), wherein the visibility component determines that the object is only visible at a reduced distance to the vehicle.
8. The system of any one or more preceding clause(s), wherein the visibility component determines a zone of visibility for the vehicle based upon the reduced distance between the object and the vehicle at the time the object is visible.
9. The system of any one or more preceding clause(s), wherein the detected hazard comprises at least one of fog, smoke, or darkness.
10. The system of any one or more preceding clause(s), wherein the detected object is another vehicle.
11. The system of any one or more preceding clause(s), wherein the object detection component determines a size or speed of the detected vehicle.
12. The system of any one or more preceding clause(s), wherein the object detection component determines an average braking distance for the detected vehicle.
13. The system of any one or more preceding clause(s), wherein the detected object is a pedestrian.
14. The system of any one or more preceding clause(s), wherein the regulation component reduces speed of the vehicle.
15. The system of any one or more preceding clause(s), wherein the regulation component activates a light of the vehicle.
16. The system of any one or more preceding clause(s), wherein the regulation component changes a setting of the vehicle.
17. The system of any one or more preceding clause(s), wherein the regulation component transmits a warning to a user of the vehicle.
18. The system of any one or more preceding clause(s), wherein the object detection component submit a warning report to a cloud server indicating the location of the detected object.
19. A computer-implemented method that utilizes a processor that executes computer executable components stored in memory to perform the following acts: detecting a hazard that reduces visibility; detecting an object using radar; determining level of visibility of the object; and regulating operation of the vehicle based on the detected hazard, detected object, and determined level of visibility of the object.
20. A computer program product comprising a computer readable storage medium having program instructions embodied therewith, the program instructions executable by a processor to cause the processor to: detect a hazard that reduces visibility; detect an object using radar; determine a level of visibility of the object; and regulate operation of the vehicle based on the detected hazard, detected object, and determined level of visibility of the object.
21. Any suitable combination of any one or more of system clauses 1-18.
22. Any suitable combination of method clause 19.
23. Any suitable combination non-transitory machine-readable storage medium clause 20.
24. Any suitable combination of any features of any one or more of clauses 1-20.

What is claimed is:

1. A system onboard a vehicle, comprising:
a memory that stores computer executable components; and
a processor that executes the computer executable components stored in memory, wherein the computer executable components comprise:
a hazard detection component that detects a hazard that reduces visibility;
an object detection component that detects an object using radar;
a visibility component that determines level of visibility of the object; and
a regulation component that regulates operation of the vehicle based on the detected hazard, detected object, and determined level of visibility of the object.

2. The system of claim 1, wherein the visibility component uses a camera to determine the level of visibility of the object.

3. The system of claim 2, wherein, upon detection of the object by the object detection component, the visibility component continuously attempts to detect the object with the camera.

4. The system of claim 3, wherein the visibility component detects the object with the camera, and determines a distance between the detected object and the vehicle.

5. The system of claim 1, wherein the object detection component determines the distance between the vehicle and the object at the time the object is detected with radar.

6. The system of claim 5, wherein the visibility component determines a distance between the vehicle and the object at the time the object becomes visible to the camera.

7. The system of claim 6, wherein the visibility component determines that the object is only visible at a reduced distance to the vehicle.

8. The system of claim 7, wherein the visibility component determines a zone of visibility for the vehicle based upon the reduced distance between the object and the vehicle at the time the object is visible.

9. The system of claim 1, wherein the detected hazard comprises at least one of fog, smoke, or darkness.

10. The system of claim 1, wherein the detected object is another vehicle.

11. The system of claim 10, wherein the object detection component determines a size or speed of the detected vehicle.

12. The system of claim 11, wherein the object detection component determines an average braking distance for the detected vehicle.

13. The system of claim 1, wherein the detected object is a pedestrian.

14. The system of claim 1, wherein the regulation component reduces speed of the vehicle.

15. The system of claim 1, wherein the regulation component activates a light of the vehicle.

16. The system of claim 1, wherein the regulation component changes a setting of the vehicle.

17. The system of claim 1, wherein the regulation component transmits a warning to a user of the vehicle.

18. The system of claim 1, wherein the object detection component submit a warning report to a cloud server indicating the location of the detected object.

19. A computer-implemented method performed by a data processing device of a vehicle, comprising:
detecting a hazard that reduces visibility;
detecting an object using radar;
determining level of visibility of the object; and
regulating operation of the vehicle based on the detected hazard, detected object, and determined level of visibility of the object.

20. A non-transitory machine-readable storage medium, comprising executable instructions that, when executed by a processor onboard a vehicle, facilitate performance of operations, comprising:
detecting a hazard that reduces visibility;
detecting an object using radar;
determining level of visibility of the object; and
regulating operation of the vehicle based on the detected hazard, detected object, and determined level of visibility of the object.
